(19) United States
(12) Patent Application Publication
(10) Pub. No.: US 2012/0269675 A1
(43) Pub. Date: Oct. 25, 2012

(54) MATERIAL FOR SPARK PLUG ELECTRODE HAVING EXCELLENT SPARK WEAR RESISTANCE AND DISCHARGE PROPERTIES

(76) Inventors: Kunihiro Tanaka, Hiratsuka-shi (JP); Muneki Nakamura, Hiratsuka-shi (JP)

(21) Appl. No.: 13/520,013

(22) PCT Filed: Feb. 16, 2011
(86) PCT No.: PCT/JP2011/053191

§ 371 Date: Jun. 29, 2012

(30) Foreign Application Priority Data
Feb. 17, 2010 (JP) 210-032189

(51) Int. Cl. H01T 13/39; C22C 5/04

(52) U.S. Cl. 420/466

(57) ABSTRACT

A material for a plug electrode having not only excellent oxidation wear resistance but also excellent spark wear, and also having adequately-considered discharge properties in use is provided. The present invention relates to a material for a plug electrode, comprising 5% by mass or more and 30% by mass or less of Cu, 0.1% by mass or more and 15% by mass or less of Ir, with the balance being Pt. Alloying by combining two metals of Cu and Ir can reduce discharge voltages and improve durability against spark wear. With addition of only one of them, the effect of improving spark wear properties is poor and the effect of reducing discharge voltages cannot be expected.

### TECHNICAL FIELD

The present invention relates to a material constituting a center electrode and an earth electrode of a spark plug, which has reliable durability particularly for spark wear and has excellent discharge properties.

### BACKGROUND ART

Spark plugs for combustion engines are required to have excellent wear resistance to be durable over a long period of time in harsh conditions in combustion chambers. To meet the required properties, materials composed of Ir, Pt, Ni or an alloy thereof have been used as a material constituting a center electrode and an earth electrode which are main components of the plug (Patent Document 1). These materials are known to be excellent for a plug electrode as they have a high melting point and are less susceptible to oxidation wear in high temperature and highly oxidative combustion chambers.

### Prior Art Document

### Patent Document

### Patent Document 1: Japanese Patent Application Laid-Open No. 2009-295427

In the development of materials for a plug electrode, focus is often placed on the improvement of durability as described above. Because they are used for an electrode (discharge electrode), however, their discharge properties are also important. In particular, although elevation in the inner temperatures and precise electronic control have recently progressed in the field of automobile engines and discharge properties may be used as an important factor in selecting materials, there have been few studies on this.

Furthermore, most of the conventional studies on the durability of materials for a plug electrode have mainly discussed the development of materials which have a high melting point and are less susceptible to wear due to oxidation even in a highly oxidative atmosphere as described above. However, plug electrodes are worn by, in addition to oxidation wear, spark wear caused by spark constantly formed during use. Therefore, although conventional theories themselves are correct, it could be necessary to consider the problem also from a standpoint of the resistance against spark wear.

### SUMMARY OF THE INVENTION

### Problems to be Solved by the Invention

Under such circumstances, an object of the present invention is to provide a material for a plug electrode having not only excellent oxidation wear resistance but also excellent spark wear properties, and also having adequately-considered discharge properties in use.

### Means for Solving the Problems

The present invention solves the above problem and provides a material for a plug electrode, comprising 5% by mass or more and 30% by mass or less of Cu, 0.1% by mass or more and 15% by mass or less of Ir, with the balance being Pt.

The material for a plug electrode according to the present invention is a ternary alloy prepared by adding Cu (copper) to platinum and further adding precious metal Ir (iridium) thereto. Alloying by combining two metals of Cu and Ir in this way can reduce discharge voltages and improve the durability against spark wear. This means that the object of the present invention cannot be achieved by adding either Cu or Ir only. More specifically, addition of Cu only has little effect of improving spark wear properties, while the effect of reducing discharge voltages cannot be expected with an alloy prepared by adding Ir only (corresponding to conventional art).

Also, in the present invention, the amounts of addition of the respective alloy metals are limited. The present inventors have found that when the amounts of addition of the metals fall outside an appropriate range, not only spark wear properties and discharge properties deteriorate, but also oxidation wear increases. In other words, the amounts of addition of the respective alloy metals must be controlled to maintain good balance of spark wear properties, discharge properties and oxidation wear properties.

Hereinafter the constitution of the Pt alloy according to the present invention will be described. Cu mainly has an action to reduce the discharge voltage of alloy materials. The amount of addition is determined to be 5 to 30% by mass because when the amount is less than 5% by mass, discharge voltage is not easily reduced, and when the amount is more than 30% by mass, wear is more likely to occur due to high temperature oxidation. The content of Cu is preferably 8% by mass or more and more preferably 10% by mass or more. This is because discharge voltage is particularly lowered.

The Pt alloy of the present invention contains 0.1% by mass or more and 15% by mass or less of Ir in addition to Cu of the above content. A small content of Ir further reduces the discharge voltage and also reduces the wear amount of electrodes for spark discharge. More specifically, the area of wear after spark discharge is decreased to about 40% as compared to a Pt alloy containing only Cu. In addition, unevenness in discharge voltages is also decreased to improve voltage stability. The present invention is characterized in that the resulting plug material has high wear resistance and excellent discharge properties even if the content of Ir is as low as described above.

The content of Ir is 0.1% by mass or more and 15% by mass or less. When the content is less than 0.1% by mass, the effect of inhibiting wear due to spark discharge is difficult to obtain, and when the content is more than 15% by mass, it tends to be difficult to process the resulting alloy. In the above content range, the relatively higher the concentration of Ir, the higher the effect of inhibiting wear due to spark discharge, and the relatively lower the concentration of Ir, the better the high temperature oxidation properties. Therefore, it is preferable to select a suitable Ir content considering conditions of use of spark plugs depending on which properties are important. More specifically, when importance is attached to the effect of inhibiting spark wear, the content of Ir is preferably 0.3% by mass or more, particularly preferably 8% by mass or more. On the other hand, when importance is attached to the high temperature oxidation properties, the content of Ir is preferably 12% by mass or less, particularly preferably 4.5% by mass or less, and more preferably 1% by mass or less. Furthermore, when importance is attached to the balance of the two as described above, the content of Ir is preferably 0.3 to 1% by mass.

The Pt alloy of the present invention described above is produced by mixing constituent metals, melting and casting. The resulting Pt alloy is processed into precious metal chips through a method of forming the alloy into a sheet material or wire and then cutting to a desired length to be used as a spark plug.

### Advantageous Effect of Invention

The Pt alloy of the present invention is a plug material having both high temperature oxidation wear resistance and spark wear resistance. The Pt alloy of the present invention also has improved stability with reduced unevenness in discharge voltages.

### BRIEF DESCRIPTION OF THE DRAWINGS

FIG. 1 illustrates the result of evaluation of wear resistance and discharge properties corresponding to the Ir content.

### DETAILED DESCRIPTION OF THE PREFERRED EMBODIMENTS

Hereinafter preferred Examples of the present invention will be described. First, for the preliminary experiment, properties of Pt—Cu alloy were evaluated to determine the influence of the addition of Cu to Pt on discharge properties.

Small pieces (size: 2 to 10 mm) of Pt and alloy metal (Cu) were prepared as raw materials and charged in a water-cooled copper mold to provide a predetermined alloy composition. Then the materials were melted through a high-frequency induction heating method (levitation melting) in inactive gas and cast. The melting conditions included an output of 40 kW and a frequency of 250 kHz, and the whole alloy was melted to form a homogeneous composition. After melting the alloy, the output was controlled to cool the alloy gradually at a cooling rate of 200° C./min, and the remaining gas was discharged to produce void-free marble ingots (15 mm in diameter, 8 mm in thickness. Next the marble ingots produced were put in a water-cooled copper mold so as to be in contact with each other and the contact portions were irradiated with argon arc to be melted and joined.

After integrating the marble ingots, the resultant was hot-forged to form an ingot of 12 mm square. Subsequently, the ingot was subjected to groove rolling, swaging and dice drawing to form wire having a diameter of 0.6 mm. In these processing steps, the ingot was heat-treated at 1000° C. to 1200° C. at the stage where the reduction in area was 20% to 50%. Precious metal chips having a length of 0.8 mm were cut from the wire. In the above processing steps, no noticeable crack or disconnection was observed in the materials processed. The metallographic structure of the wire after processing was observed and as a result the material was found to be homogeneous with uniform crystal grains. The resulting precious metal chips were subjected to the evaluation of the residual rate after high temperature oxidation and discharge properties as follows.

### [High Temperature Oxidation Wear Resistance]

The high temperature oxidation wear resistance of the precious metal chips produced was evaluated. The chips were heated in the air at 1200° C. for 50 hours and the residual rate was calculated based on the measurements of the weight before and after the experiment.

### [Discharge Properties]

A precious metal wire having φ0.6 mm was used to measure the discharge voltage. The precious metal wire was used for a center electrode and a grounding electrode and the gap between them was set to be 1.0 mm. Current was discharged in nitrogen atmosphere (6 atm) for 140 hours and the voltage was measured for about 2 minutes at intervals of 28 minutes. The maximum voltage and the average voltage in each measuring interval were determined and the maximum value of the maximum voltages, the average value of the average voltages and the respective standard deviations were calculated.

### [Spark Wear Properties]

The wear amount for spark wear was also the subject of evaluation. The spark wear was evaluated by measuring the area of wear based on the dimensional measurements of the tip of the precious metal chips before and after discharge property.

TABLE 1

| | | | Durability | | | | | |
|---|---|---|---|---|---|---|---|---|
| | Alloy | | Residual rate | | Discharge properties | | | |
| | composition | | after high | | Maximum voltage | | Average voltage | |
| | (% by mass) | | temperature | Spark wear | Maximum | Standard | Average | Standard |
| | Pt | Cu | oxidation | area | voltage | deviation | voltage | deviation |
| Reference Example 1 | 95.0 | 5.0 | 99.02% | 6118 μm² | 12.81 kV | 0.31 | 9.52 kV | 0.19 |
| Reference Example 2 | 90.0 | 10.0 | 98.31% | 9149 μm² | 19.10 kV | 0.78 | 8.34 kV | 0.21 |
| Reference Example 3 | 75.0 | 25.0 | 91.14% | 2719 μm² | 15.00 kV | 0.99 | 8.56 kV | 0.20 |
| Reference Example 4 | 55.0 | 45.0 | 61.33% | 10095 μm² | 27.50 kV | 0.43 | 8.56 kV | 0.09 |
| Comparative Example 1 | 100 | — | 98.68% | 7086 μm² | 13.44 kV | 0.57 | 9.92 kV | 0.19 |

* The maximum voltage means the maximum value of the maximum voltages in each measuring interval.
* The average voltage means the average value of the average voltages in each measuring interval.

Table 1 shows that when containing Cu, the Pt alloy is effective in reducing the average voltage. On the other hand, an increase in the Cu content is likely to cause a decrease in the residual rate of Pt alloy after high temperature oxidation. For this reason, and the balance between the reduction of discharge voltage and wear due to high temperature oxidation is taken into consideration, the content of Cu is set at 5 to 30% by mass in the present invention.

Next, precious metal chips composed of Pt—Cu—Ir alloy were prepared and subjected to the evaluation of the residual rate after high temperature oxidation and discharge properties. The precious metal chips were produced in the same manner as in the preliminary experiment, and the residual rate after high temperature oxidation, discharge properties and the spark wear amount after discharge were similarly evaluated.

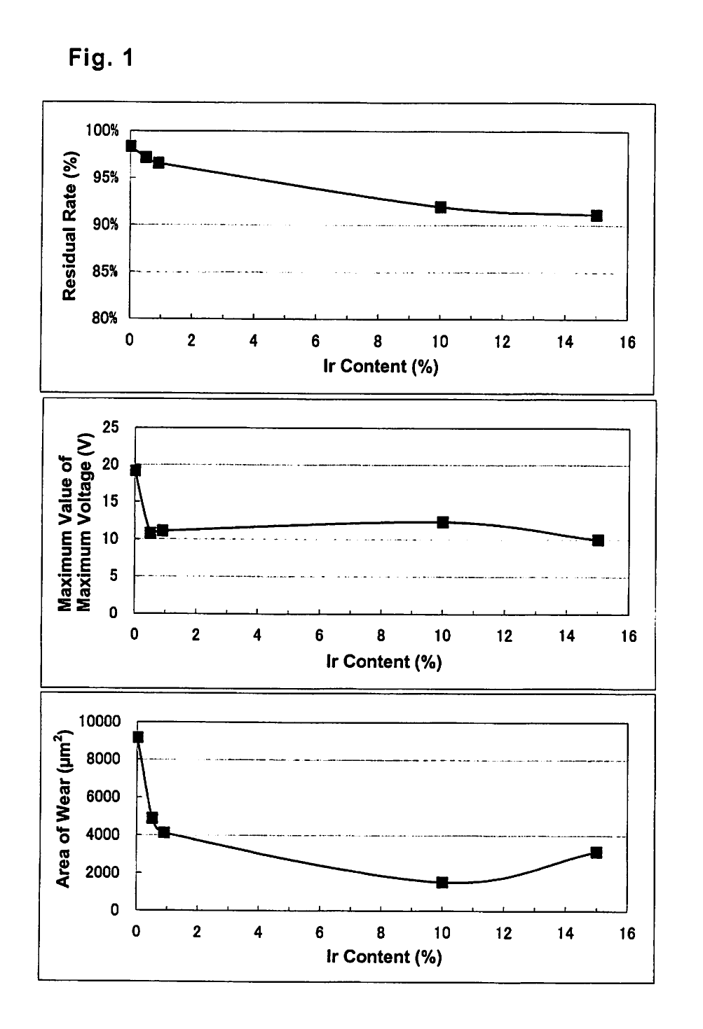

The result of evaluation is shown in Table 2. Table 2 shows the result of evaluation of precious metal chips composed of Pt—Cu alloy (Reference Example 2, alloy containing 10% of Cu) and those composed of Pt—Ir alloy (containing 20% of Ir) for comparison. Also FIG. 1 shows the result of evaluation of alloys in which the concentration of Cu is constant (10% by mass) while the concentration of Ir is changed.

TABLE 2

| | | | | Durability | | | | | |
|---|---|---|---|---|---|---|---|---|---|
| | | | | Residual rate | | Discharge properties | | | |
| | Alloy composition | | | after high | | Maximum voltage | | Average voltage | |
| | (% by mass) | | | temperature | Spark wear | Maximum | Standard | Average | Standard |
| | Pt | Cu | Ir | oxidation | area | voltage | deviation | voltage | deviation |
| Example 1 | Balance | 10 | 0.5 | 97.15% | 4884 μm² | 10.78 kV | 0.43 | 7.45 kV | 0.22 |
| Example 2 | Balance | 10 | 0.9 | 96.54% | 4116 μm² | 11.09 kV | 0.32 | 8.47 kV | 0.17 |
| Example 3 | Balance | 10 | 10 | 91.98% | 1539 μm² | 12.34 kV | 0.55 | 8.07 kV | 0.28 |
| Example 4 | Balance | 10 | 15 | 91.12% | 3166 μm² | 10.00 kV | 0.20 | 8.37 kV | 0.19 |
| Example 5 | Balance | 17 | 8 | 91.99% | 1640 μm² | 14.02 kV | 0.41 | 8.44 kV | 0.21 |
| Example 6 | Balance | 23 | 2 | 92.02% | 2602 μm² | 13.20 kV | 0.36 | 8.51 kV | 0.20 |
| Reference Example 2 | Balance | 10 | — | 98.31% | 9149 μm² | 19.10 kV | 0.78 | 8.34 kV | 0.21 |
| Comparative Example 1 | 100 | — | — | 98.68% | 7086 μm² | 13.44 kV | 0.57 | 9.92 kV | 0.19 |
| Comparative Example 2 | Balance | — | 20 | 91.08% | 8597 μm² | 18.72 kV | 0.72 | 10.37 kV | 0.08 |

* The maximum voltage means the maximum value of the maximum voltages in each measuring interval.
* The average voltage means the average value of the average voltages in each measuring interval.

Table 2 and FIG. 1 show that further addition of Ir to the Pt—Cu alloy results in a significant decrease in the spark wear area. It has also been found even for the discharge properties that the effect of reducing the maximum voltage as well as the effect of reducing the average voltage was produced, and also their unevenness (standard deviation) was reduced. In this embodiment alloys in which the total content of Cu and Ir was 25% by mass or less were studied, and it has been shown that these alloys are preferred as they can keep the residual rate after high temperature oxidation at a high level.

Because processability is decreased when more than 15% by mass of Ir is added, however, Ir is preferably added at 15% or less. This has been proved from the result that when an alloy prepared by adding more than 15% by mass of Ir was experimentally formed into an ingot and then wire, disconnection frequently occurred, and although processing was not completely impossible, the production efficiency was low.

### INDUSTRIAL APPLICABILITY

The present invention provides a material for a plug electrode which has high wear resistance and is durable over a long period of time. In addition, with little unevenness in discharge voltages, the stability when using the plug is improved.

1. A material for a plug electrode, comprising 5% by mass or more and 30% by mass or less of Cu, 0.1% by mass or more and 15% by mass or less of Ir, with the balance being Pt.

2. The material for a plug electrode according to claim 1 wherein the content of Cu is 8% by mass or more.

3. The material for a plug electrode according to claim 1 wherein the content of Cu is 10% by mass or more.

4. The material for a plug electrode according to claim 1 wherein the content of Ir is 0.3% by mass or more.

5. The material for a plug electrode according to claim 1 wherein the content of Ir is 8% by mass or more.

6. The material for a plug electrode according to claim 1 wherein the content of Ir is 12% by mass or less.

7. The material for a plug electrode according to claim 1 wherein the content of Ir is 4.5% by mass or less.

8. The material for a plug electrode according to claim 1 wherein the content of Ir is 1% by mass or less.

9. The material for a plug electrode according to claim 1 wherein the content of Ir is 0.3% by mass or less.

10.-20. (canceled)
